(19) United States
(12) Patent Application Publication
(10) Pub. No.: US 2004/0095229 A1
(43) Pub. Date: May 20, 2004

(54) Anti-theft and two-way communication apparatus for vehicles

(75) Inventor: Stephen Chen, Chang-Hua (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 10/294,645

(22) Filed: Nov. 15, 2002

(51) Int. Cl. B60R 25/10

(52) U.S. Cl. 340/426.1

(57) ABSTRACT

An anti-theft and two-way communication apparatus for vehicles and particularly an apparatus capable of examining incoming phone numbers to prevent vehicle theft. The apparatus mainly consists of a communication module and a vehicle anti-theft module. A fixed line or wireless telephone with a preset phone number may be dialed to the communication module to set or release the vehicle anti-theft module thereby to greatly reduce vehicle theft. The signals of the incoming phone number are generated by communication systems thus cannot be forged or replicated illegitimately, and can prevent replication by burglars during the remote control operation.

### BACKGROUND OF THE INVENTION

1. Field of the Invention

The invention relates to an anti-theft and two-way communication apparatus for vehicles and particularly an apparatus capable of examining incoming phone numbers to prevent detection or replication to effectively reduce vehicle thefts.

2. Description of the Prior Art

In recent years vehicle ownership increases rapidly as people's income increases. In the mean time, stolen vehicles also increase. This is a big concern to vehicle owners. Most vehicle owners try every possible measure to protect their vehicles and to prevent vehicle stealing from happening, such as taking insurance, installing anti-theft devices, contracting safety protection services, etc. Among those measures, installing anti-theft device is the most commonly adopted practice. As its cost is most affordable. In the event of the vehicle subjects to illegitimate invading or intrusion, the vehicle anti-theft device will generate audio alarm to svehiclee away the burglar. However, most vehicle anti-theft devices are set and released by vehicle owners in a remote manner. The remote controller is easy to replicate and does not have unique features. Its safety and protection effect is not totally desirable.

### SUMMARY OF THE INVENTION

Therefore the primary object of the invention is to provide an anti-theft and two-way communication apparatus for vehicles that use incoming phone numbers to activate the vehicle safety system. As the signals of the incoming phone numbers are generated by a communication system and cannot be replicated, they can increase the safety protection of the vehicle. In addition, in the event of the anti-theft module is triggered, it automatically notices the vehicle owner by telephone. Thus it can effectively reduce vehicle theft.

The anti-theft and two-way communication apparatus according to the invention mainly consists of a communication module and a vehicle anti-theft module. Users can only use a fixed line or a wireless telephone with preset phone numbers to set or release the vehicle anti-theft module. Hence vehicle theft can be greatly reduced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of the invention.

FIG. 2 is a block diagram of the communication module of the invention.

FIG. 3 is a structural block diagram of another embodiment of the invention.

### DESCRIPTION OF THE PREFERRED EMBODIMENTS

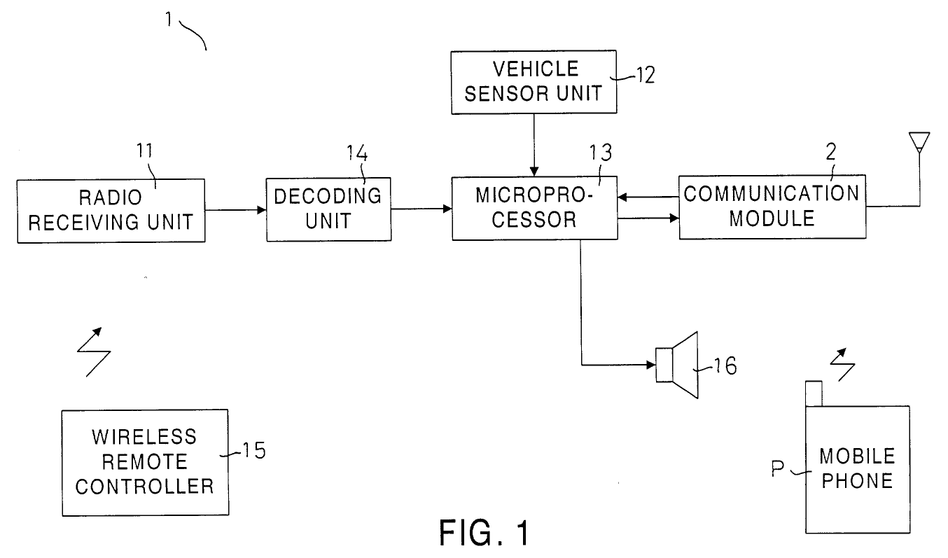

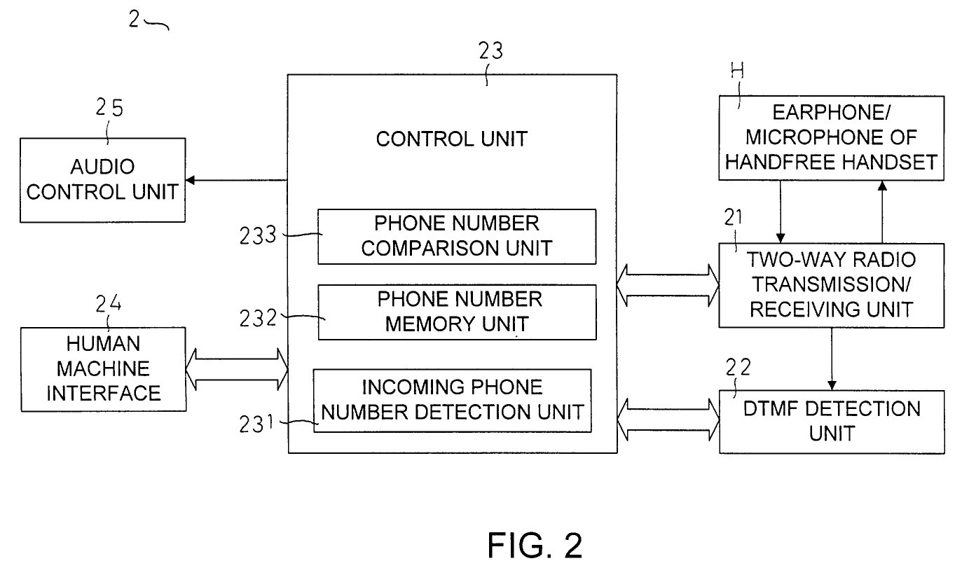

Referring to FIGS. 1 and 2, the apparatus of the invention mainly includes a vehicle anti-theft module 1 and a communication module 2, wherein:

the vehicle anti-theft module 1 includes:

a radio receiving unit 11 for receiving radio signals (such as radio waves, infrared light, bluetooth signals, or the like) emitted from a wireless remote controller 15;

a vehicle sensor unit 12 to detect alterations of the vehicle condition (such as activation of lights in the vehicle, opening of vehicle doors, etc.), and output a trigger signal to a microprocessor 13;

a microprocessor 13 to control operations of various units of the anti-theft module 1, and receive signals from a decoding unit 14 and order other units to respond, and receive anti-theft trigger signals to order an alarm speaker 16 to generate audio alarm or the communication module 2 to transmit signals;

a decoding unit 14 to decode the radio signals of a wireless remote controller 15 and transfer to the microprocessor 13 for processing;

a wireless remote controller 15 emitting remote control signals for setting the activation or closing of the anti-theft module 1;

an alarm speaker 16 to receive control of the microprocessor 13 and generate audio alarm.

the communication module 2 includes:

a two-way radio transmission/receiving unit 21 to receive and transmit commands transmitted from communication devices outside the vehicle (such as GSM transmission processor) to enable users to dial the phone numbers, and to receive and transmit mobile phone signals;

a DTMF detection unit 22 to transform the audio signals (1-9, *, #) received by the two-way radio transmission/receiving unit 21 from a mobile phone P to provide a control unit 23 to use (such as: button key 1 for activating anti-theft, button key 2 for releasing anti-theft, button key 3 for searching vehicle, etc.);

a control unit 23 linking to the anti-theft module 1 for remote control, and control operation of various units of the communication module. It consists of an incoming phone number detection unit 231 for examining data of the incoming phone number, a phone number memory unit 232 for setting phone numbers to activate and close the anti-theft module 1, and a phone number comparison unit 233 for comparing whether the phone numbers in the phone number memory unit 232 are same as the incoming phone numbers;

a human machine interface 24 serving as an interface between the user and the control unit 23 (interfaces such as button keys, which may include 0-9, *, #, transmission, cancel, etc., or LED indication lights, wireless dialing, and the like); and

an audio control unit 25 to mute or pause the vehicle stereo system while the two-way radio transmission/receiving unit 21 is operating (the technique of this portion is known in the art and forms no part of the invention, thus details are omitted).

By means of the construction set forth above, users may use the two-way radio transmission/receiving unit 21 to couple with an earphone/microphone of a handfree handset H and the human machine interface 24 to dial and use the mobile phone. When the vehicle is parked and setting anti-theft is desired, users may use a fixed line or a wireless telephone P to dial the set phone number in the two-way radio transmission/receiving unit 21. When the call is connected, the incoming phone number detection unit 231 examines the calling phone number and transfers to the phone number comparison unit 233 and the control unit 23 to compare with the phone number stored in the phone number memory unit 232. If the calling phone number matches the phone number stored in the phone number memory unit 232, the DTMF detection unit 22 detects the transmitted DTMF code, and decodes the function to be executed, such as activate the anti-theft module 1, close the anti-theft module 1, etc.

In order to facilitate user selection, the invention may simultaneously enable the wireless remote controller 15 or mobile phone P to activate the anti-theft module 1 in the remote fashion. But to maintain the non-replicatable feature of the invention, a priority sequence may be set for the remote control of the wireless remote controller 15 and the phone P. For instance, if the anti-theft function is activated by the wireless remote controller 15, then release of the anti-theft function may be achieved through the wireless remote controller 15 and the phone P. If the anti-theft function is activated by the phone, then only the approved phone number is allowed to release the anti-theft function. Moreover, the approved phone number may be more than one. Thus if one of the phone numbers is lost or ineffective, other phone numbers may be used to release the anti-theft function.

Moreover, when the anti-theft module 1 is activated and the vehicle door is opened, the microprocessor 13 will be triggered and the alarm speaker 16 will generate alarming sound. Meanwhile the microprocessor 13 outputs signals to the communication module 2, and the control unit 22 orders the two-way radio transmission/receiving unit 21 to dial a preset phone number to notice vehicle owner or designated persons.

In addition, it often happens that people forget where the vehicle is located in a large parking lot. In such an occasion, the user may dial the phone number and input a DTMF number (such as pushbutton key 3) for searching the vehicle. Once the use depresses the phone key (such as button key 3), the alarm speaker 16 will generate sound in a short interval to enable the user to locate the vehicle.

Furthermore, in the event of poor communication occurs to the communication module 2, the priority of releasing the communication module 2 to open vehicle door and anti-theft function may be set automatically.

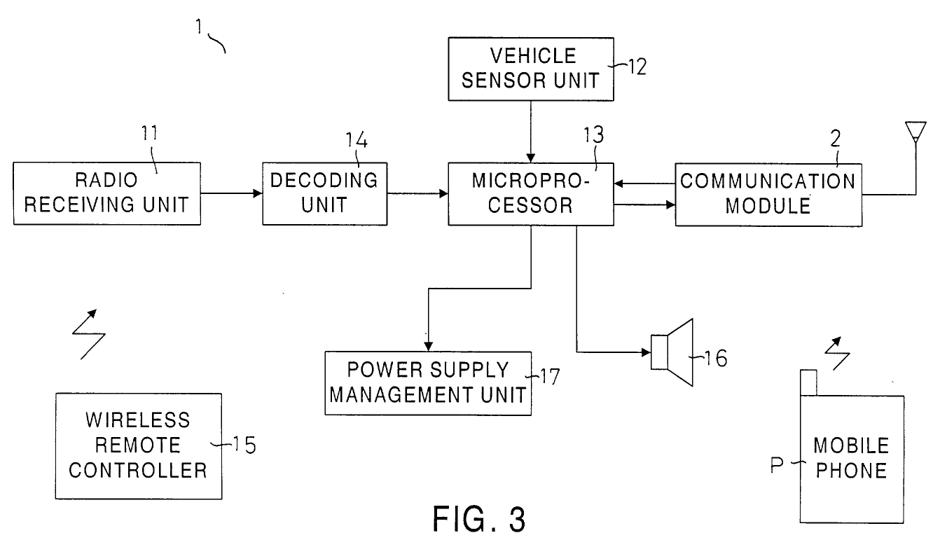

Refer to FIG. 3 for another embodiment of the invention. In this embodiment a power supply management unit 17 is added to connect to the microprocessor. When the vehicle is idle for a long period of time or battery voltage is detected too low, a signal may be transmitted to the microprocessor to turn off the communication apparatus, and release the priority of opening vehicle door and anti-theft function in the communication apparatus.

In summary, the invention employs incoming phone numbers that cannot be replicated as the means to activate or close the vehicle anti-theft function. It can thoroughly resolve the problems and disadvantages that exist in the conventional anti-theft devices.

The embodiments disclosed above only to serve exemplary purpose and should not be deemed as the limitation of the invention. For instance, the wireless remote controller and radio transmission and receiving unit have many other choices in addition to the infrared light transmission unit and bluetooth transmission unit mentioned in the description. Modifications of the disclosed embodiments of the invention as well as other embodiments thereof may occur to those skilled in the art. Accordingly, the appended claims are intended to cover all embodiments which do not depart from the spirit and scope of the invention.

I claim:

1. An anti-theft and two-way communication apparatus for vehicles comprising a vehicle anti-theft module and a communication module, wherein:
the communication module includes:
a two-way radio transmission/receiving unit to receive and transmit commands from communication devices outside a vehicle;
a DTMF detection unit to transform audio signals of telephones; and
a control unit linking to the anti-theft module to remote control of anti-theft function, and control operations of various units of the communication module;
the vehicle anti-theft module includes:
a vehicle sensor unit to detect alterations of vehicle conditions and to output a trigger signal to the microprocessor; and
a microprocessor to control operations of various units of the vehicle anti-theft module, and order other units to respond, and receive the triggered anti-theft signal from the vehicle sensor unit.

2. The anti-theft and two-way communication apparatus for vehicles of claim 1, wherein the control unit includes:
an incoming phone number detection unit for examining data of incoming phone numbers;
a phone number memory unit for setting phone numbers to activate and close the anti-theft module; and
a phone number comparison unit for comparing whether the phone numbers in the phone number memory unit are same as the incoming phone numbers.

3. The anti-theft and two-way communication apparatus for vehicles of claim 1, wherein the communication module further includes a handfree handset for transmitting sound in the vehicle through the two-way radio transmission/receiving unit to a communication module outside the vehicle when anti-theft is triggered.

4. The anti-theft and two-way communication apparatus for vehicles of claim 1, wherein the communication module further includes an audio control unit to mute or pause the vehicle stereo system when the two-way radio transmission/receiving unit operates.

5. The anti-theft and two-way communication apparatus for vehicles of claim 1, wherein the two-way radio transmission/receiving unit is a GSM communication processor.

6. The anti-theft and two-way communication apparatus for vehicles of claim 1, wherein the communication module further includes a human machine interface to serve as an interface between users and the control unit.

7. The anti-theft and two-way communication apparatus for vehicles of claim 1, wherein the vehicle anti-theft module further includes an alarm speaker controlled by the microprocessor to generate alarming sound.

8. The anti-theft and two-way communication apparatus for vehicles of claim 1, wherein the vehicle anti-theft module further includes:
a wireless remote controller for emitting remote control signals to set activation or closing of the anti-theft module;
a radio receiving unit for receiving radio signals emitted from the wireless remote controller; and
a decoding unit for decoding the radio signals of the wireless remote controller and transferring to the microprocessor for processing.

9. The anti-theft and two-way communication apparatus for vehicles of claim 8, wherein the wireless remote controller and the radio receiving unit are infrared light transmission units.

10. The anti-theft and two-way communication apparatus for vehicles of claim 8, wherein the wireless remote controller and the radio receiving unit are bluetooth transmission units.

11. The anti-theft and two-way communication apparatus for vehicles of claim 1, wherein the vehicle anti-theft module further includes a power supply management unit linking to the microprocessor for controlling the communication module.
